(19) United States
(12) Patent Application Publication
(10) Pub. No.: US 2015/0345664 A1
(43) Pub. Date: Dec. 3, 2015

(54) ASSEMBLY FOR THE INSTALLATION OF GEOTHERMAL CONDUITS ADJACENT A FOUNDATION WALL INSIDE OR OUTSIDE A BUILDING STRUCTURE

(71) Applicant: Brooke Erin DESANTIS, Montreal (CA)

(72) Inventor: Alain DESMEULES, Montreal (CA)

(21) Appl. No.: 14/823,181

(22) Filed: Aug. 11, 2015

Related U.S. Application Data
(63) Continuation of application No. 13/037,396, filed on Mar. 1, 2011.

(51) Int. Cl. F16L 1/028; F16L 1/06; F24J 3/08

(52) U.S. Cl. CPC F16L 1/028; F24J 3/082; F16L 1/06; F24J 2003/088

(57) ABSTRACT

An assembly for installing geothermal conduit loops into the ground under an existing foundation, including a support platform including a plurality of beam sections interconnected to form an elongated support beam having a longitudinal axis, the plurality of beam sections including first and second beam sections each defining a respective end of the elongated support beam, each of the first and second beam sections including an attachment flange attached to the respective end of the elongated support beam, each attachment flange defining a flange plane oriented non-perpendicularly to the longitudinal axis, each attachment flange configured for detachable securement to a respective one of adjoining walls of the foundation.

### CROSS-REFERENCE TO RELATED APPLICATIONS

This application is a continuation of U.S. application Ser. No. 13/037,396 filed on Mar. 1, 2011, the entire contents of which are incorporated by reference herein.

### TECHNICAL FIELD

The present invention relates to an assembly for the installation of geothermal conduits adjacent a foundation wall inside or outside a building structure.

### BACKGROUND ART

Reference is made to U.S. application Ser. No. 12/320,754, entitled “System and method for geothermal conduit loop in-ground installation and soil penetrating head therefor”, filed Feb. 4, 2009, in which there is disclosed a drive mechanism to drive a force transmitting shaft into the ground to install geothermal conduit loops therein. Geothermal systems are usually installed remote from a building structure by drilling holes into the ground and in which conduits are installed. This usually requires heavy and bulky machinery. It is also difficult to adapt geothermal systems to existing buildings or residential dwellings where land mass around most of these dwellings is very restricted. It is very difficult in such limited space to use heavy machinery to drive pipes into the ground or to drive conduit loops into the ground. When installing a geothermal conduit system into the ground it is often required to bore several holes within the ground and to install several conduit loops and to interconnect them together. This requires extensive excavations or surface area to install a complete system.

The use of thermal energy is becoming more and more important due to the high cost of combustible products or electrical energy. Accordingly, existing building structures with limited land thereabout can only convert to geothermal energy if such energy can be captivated from under the existing foundation of the building or very close thereto. Accordingly, such geothermal conduits need to be driven into the soil from the basement concrete floor of the foundation or in a limited space outside the foundation walls. The use of heavy machinery to drive soil penetrating shafts into the ground is not possible for such restricted spaces. Therefore, the solution is to have a modular system whereby the parts thereof are easily transportable and can be assembled by a small work force such as a two person crew and operated in an existing basement of a building.

### SUMMARY OF INVENTION

In at least some embodiment, the present invention provides a support assembly for a drive mechanism adapted to drive a force transmitting shaft having a soil penetrating head with a geothermal conduit loop attached thereto into the ground under an existing basement concrete floor of a building structure or closely adjacent transverse foundation walls.

In at least some embodiments, the present invention provides a support assembly for a drive mechanism adapted to drive a force transmitting shaft having a soil penetrating head with a geothermal conduit loop attached thereto into the ground under an existing basement concrete floor by the use of interconnectable support platform sections which are removably attachable to opposed transverse foundation walls of a basement concrete structure.

In at least some embodiments, the present invention provides a support assembly for a drive mechanism adapted to drive a force transmitting shaft having a soil penetrating head with a geothermal conduit loop attached thereto into the ground and wherein the support assembly has a turret support base capable of orienting the drive mechanism at different angles to install several conduit loops into the ground in an area under the turret support base and wherein the drive mechanism can also be angulated at different angular positions.

In at least some embodiments, the present invention provides a method of installing a geothermal conduit system interiorly under a basement concrete floor or exteriorly adjacent a concrete foundation.

In one aspect, there is provided a support assembly for a drive mechanism adapted to drive a force transmitting shaft having a soil penetrating head with a geothermal conduit loop attached thereto into the ground under an existing basement concrete floor of a building structure through a hole formed in the concrete floor. The support assembly comprises a support platform formed of platform sections having interconnecting means for interconnection together. Attachment means is provided at opposed ends of at least some of the support platform sections for detachable securement to a respective one of opposed transverse foundation walls adjacent the concrete floor whereby the support assembly extends diagonally between the opposed transverse walls.

In another aspect, there is provided a support assembly for a drive mechanism adapted to drive a force transmitting shaft having a soil penetrating head with a geothermal conduit loop attached thereto into the ground adjacent foundation walls of a building structure. The support assembly comprises a support platform formed of sections having interconnecting means for interconnection together. Attachment means is secured to at least two of these sections for detachable securement to a respective one of opposed transverse foundation walls of the building structure. One of the sections projects exteriorly of the foundation walls and has a support means for securing the drive mechanism spaced from the foundation walls whereby to drive the force transmitting shaft at different angles into the ground.

In another aspect, there is provided a method of installing a geothermal conduit system under a basement concrete floor. The method comprises forming a hole in the concrete floor spaced from opposed transverse foundation walls to expose the soil thereunder. A support platform is assembled from platform sections. Opposed ends of the assembled support platform are secured to a respective one of the opposed transverse foundation walls with the support platform extending at least partly over the hole. A drive mechanism is secured to the support platform over the hole. A force transmitting shaft having a soil penetrating head is secured to the drive mechanism. A geothermal flexible conduit loop is secured to the soil penetrating head. The drive mechanism is operated to displace the force transmitting shaft into the ground to bury at least part of the geothermal flexible conduit loop.

In another aspect, there is provided an assembly for installing geothermal conduit loops into the ground under an existing foundation, the assembly comprising: a support platform including a plurality of beam sections interconnected to form an elongated support beam having a longitudinal axis, the plurality of beam sections including first and second beam sections each defining a respective end of the elongated support beam, each of the first and second beam sections including an attachment flange attached to the respective end of the elongated support beam, each attachment flange defining a flange plane oriented non-perpendicularly to the longitudinal axis, each attachment flange configured for detachable securement to a respective one of adjoining walls of the foundation; a turret support base secured to the support platform; a drive support base pivotally and detachably engaged on the turret support base such as to be pivotable relative thereto about a first axis; a drive mechanism engaged to the drive support base such as to be pivotable relative thereto about a second axis non-parallel to the first axis; and a force transmitting shaft drivingly engaged to the drive mechanism and extending downwardly therefrom, the force transmitting shaft having a soil penetrating head configured to penetrate the soil while engaging one of the conduit loops when the force transmitting shaft is driven by the drive mechanism.

In a further aspect, there is provided an assembly for installing geothermal conduit loops into the ground adjacent an existing foundation, the assembly comprising: a support platform including: a first beam section having a first longitudinal axis and opposed first and second ends, a first attachment flange connected to the first beam section adjacent the second end thereof, the first attachment flange defining a first flange plane parallel to the first longitudinal axis, a second beam section having a second longitudinal axis non-parallel to the first longitudinal axis and opposed first and second ends, the first end of the second beam section being connected to the first beam section between the first and second ends thereof, a second attachment flange connected to the second beam section adjacent the second end thereof, the second attachment flange defining a second flange plane parallel to the second longitudinal axis, wherein the first and second attachment flanges are each configured for detachable securement to an exterior surface of a respective one of adjoining walls of the foundation; a turret support base secured to the first beam section adjacent the first end thereof; a drive support base pivotally and detachably engaged on the turret support base such as to be pivotable relative thereto about a first axis; a drive mechanism engaged to the drive support base such as to be pivotable relative thereto about a second axis non-parallel to the first axis; and a force transmitting shaft drivingly engaged to the drive mechanism and extending downwardly therefrom, the force transmitting shaft having a soil penetrating head configured to penetrate the soil while engaging one of the conduit loops when the force transmitting shaft is driven by the drive mechanism.

### BRIEF DESCRIPTION OF DRAWINGS

A preferred embodiment of the present invention will now be described with reference to the accompanying drawings in which:

FIG. 1 is a schematic view showing a plurality of geothermal conduit loops installed into the ground under an existing foundation of a building structure and interconnected together to form a geothermal conduit system which is secured to a heat exchange device to heat air within the building structure or to cool air within the building structure;

FIG. 2 is a perspective view showing the support assembly in an assembled state and connected across opposed transverse foundation walls of a building structure with a hole having been made in the basement concrete floor and a drive mechanism secured to the support assembly over the hole;

FIG. 3 is an enlarged perspective view showing the construction of the drive mechanism and its securement to a section of the support beam assembly;

FIG. 4 is a side view of the drive mechanism secured to the beam assembly and illustrating the position of the angulated end attachment plate securable to the foundation walls as well as illustrating the adjustable inclination support rod; and

FIG. 5 is a top view of a schematic diagram showing various modifications to the support assembly for supporting a drive mechanism over a hole formed in a basement concrete floor adjacent opposed transverse foundation walls or in a restricted exterior area of the opposed transverse foundation walls.

### DESCRIPTION OF PREFERRED EMBODIMENTS

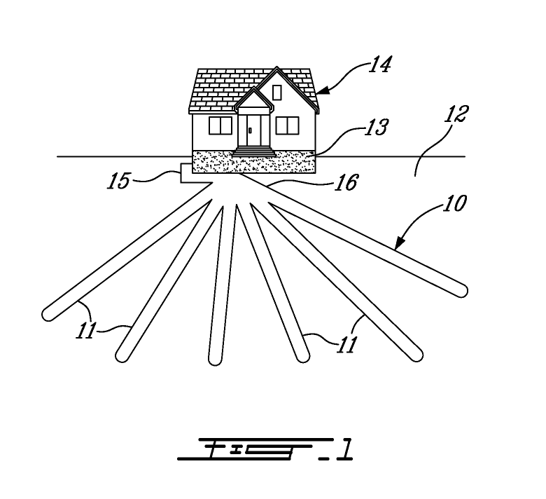

Referring now to the drawings, and more particularly to FIG. 1, there is schematically illustrated a geothermal conduit system 10 consisting of a plurality of geothermal conduit loops 11 installed into the ground 12 under a foundation 13 of a building structure 14, herein a residential building structure. As hereinshown, the conduit loops 11 are interconnected in an upper region above ground in a series configuration whereby a fluid can be circulated through the series assembly of loops from an input end 15 to an output end 16 which are connected to a heat exchange device, not shown herein but obvious to a person skilled in the art, to extract heat from the ground or release heat into the ground to cool the fluid. Reference is herein made to our co-pending application Ser. No. 12/320,754 and entitled “System and method for geothermal conduit loop in-ground installation and soil penetrating head therefor” the contents of which is incorporated herein by reference.

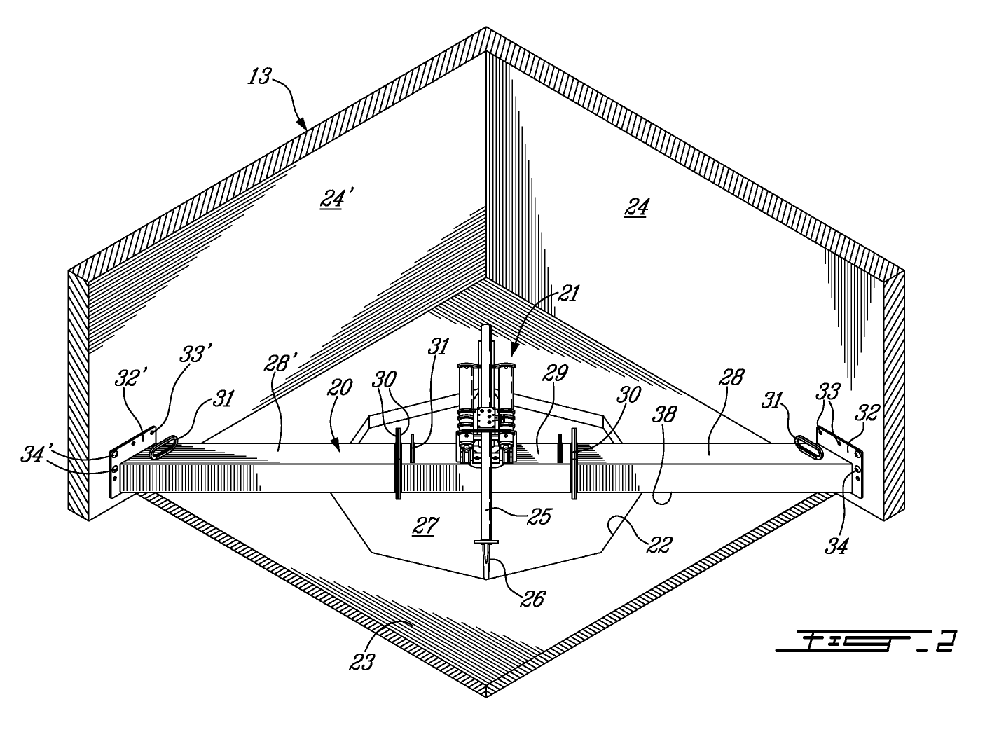

Referring now to FIGS. 2 to 4, there will be described the support assembly 20 of the present invention to support a drive mechanism 21 over a hole 22 formed in an existing basement concrete floor 23 of the building structure 14 as shown in FIG. 1, and adjacent opposed transverse foundation walls 24 and 24′ of the foundation 13. The drive mechanism 21 is adapted to drive a force transmitting shaft 25 having a soil penetrating head 26 into the ground 27. Attached to the soil penetrating head 26 is a conduit loop 11 as shown in FIG. 1. The force transmitting shaft 25 is driven into the ground 27 to a predetermined depth and to do so the force transmitting shaft 25 is formed of short sections which are interconnected end-to-end and easy to transport and assemble in a limited space. FIG. 2 shows the bottom section only of the force transmitting shaft.

Due to the limited space in a basement of an existing building, the support assembly 20 is constructed of support platform sections 28, 28′ and 29. The section 29 is a central platform section to which a drive mechanism is secureable, while the other two sections 28 and 28′ are connected to opposed ends thereof by interconnecting flanges 30. These platform sections facilitate the transport thereof due to their smaller size and the limited space available to transport these into an existing basement. Carrying handles 31 are provided on each of the platform sections 28, 28′ and 30 to facilitate its transport.

As also shown in FIG. 2 attachment means in the form of attachment flanges 32 and 32′ are provided at the free ends of the sections 28 and 28′ and these are provided with holes 33 and 33′ to receive anchor bolts 34 and 34′ to secure the support assembly 20 to the opposed transverse foundation walls 24 and 24′. As can be seen, these attachment flanges 32 and 32′ define a flange plane which is a substantially planar surface delimited by the face of the attachment flanges 32 and 32′. The flange plane is oriented parallel to, and offset from, the plane defined by the foundation walls when the flange plane is installed thereagainst. The flange plane can intersect a straight axis of a corresponding section 28 and 28′, and is oriented at an angle that is different from 90°, i.e. is not perpendicular. In other words, the flange plane is not normal to the straight axis which intersects it. In a preferred embodiment, the flange planes of the attachment flanges 32 and 32′ are angulated at an angle of 45 degrees whereby to support the assembly 20 diagonally between the opposed transverse walls 24 and 24′.

As shown in FIG. 2, there are three platform sections constituted by hollow metal support beams but the assembly could also be constituted by two or more than three of these beam sections whereby to construct a support beam assembly 20 along a straight axis to form an elongated straight support beam. The platform beams are assembled resting on the floor 23.

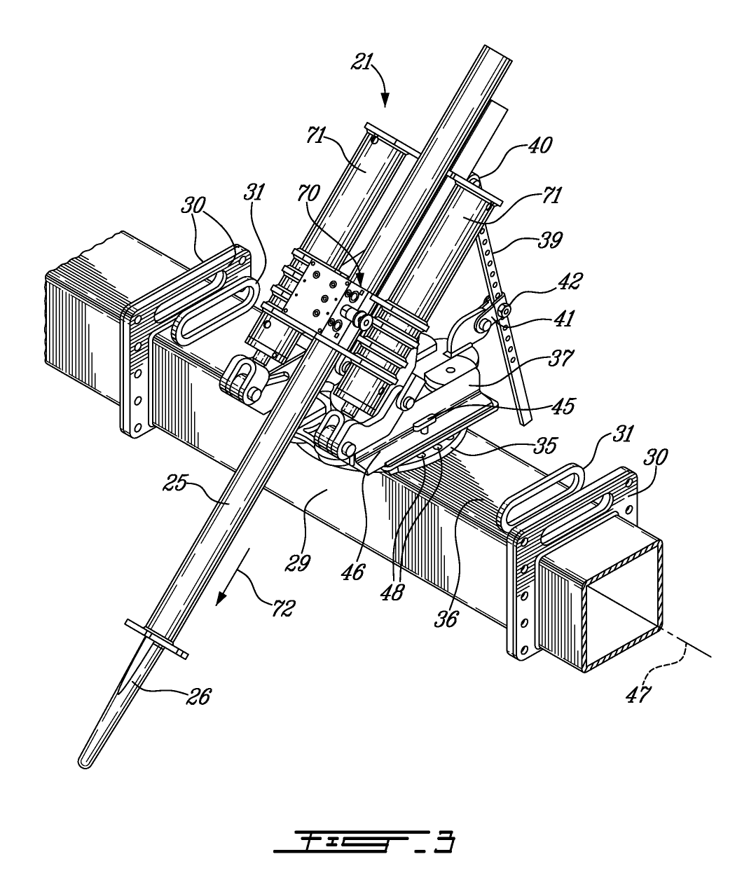

As more clearly illustrated in FIG. 3, a turret support base 35 is secured to the top wall 36 of the central platform section 29 and the drive mechanism is provided with a support base 37 which is detachably secured to the turret support base 35. The connecting mechanism is not shown herein but can consist of several turret attachments obvious to a person skilled in the art. The turret support base makes it possible for the drive mechanism 21 to be oriented at a desired position relative to the support beam and the hole 22 thereunder. To facilitate the assembly of the platform sections 28, 28′ and 29 these are assembled resting on the basement concrete floor 23. As can be seen, the end attachment flanges 32 and 32′ do not extend under the lower surface 38 of the end beams 28 and 28′. Accordingly, it is not necessary to lift the opposed side beam sections 28 and 28′ during assembly and the central platform beam 29 is made smaller, thus lighter, for ease of installation. Of course, the drive mechanism 21 is assembled only after the entire support assembly is connected to the opposed vertical side walls 24 and 24′.

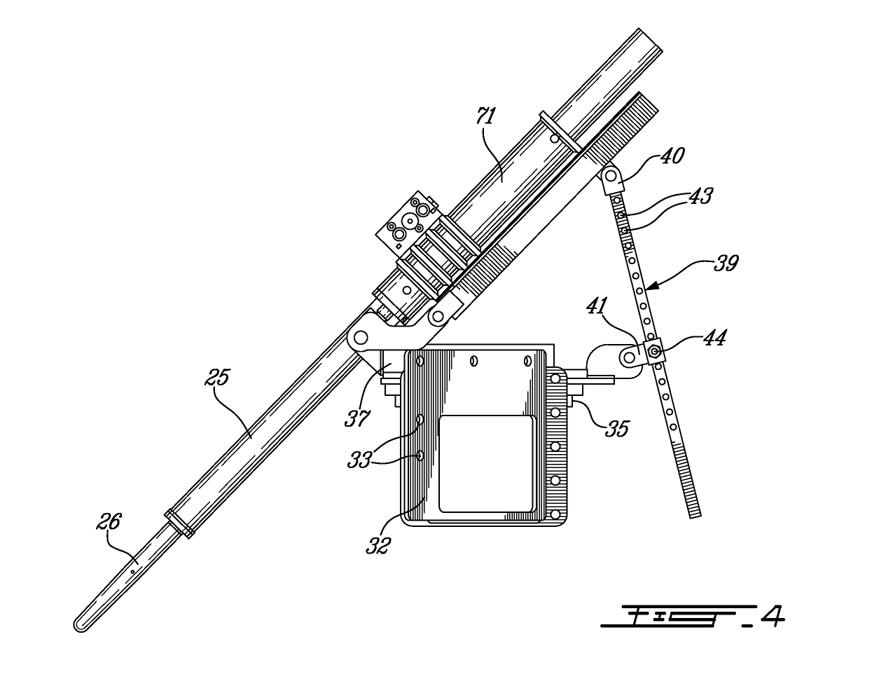

With reference now to FIGS. 3 and 4 it can be seen that the drive mechanism 21 is also provided with an adjustable inclination means, herein constituted by an adjustable support rod 39, pivotally connected at a top end thereof to a pivot connection 40. The adjustable support rod 39 is also guidingly received and displaceable in a pivoting linkage 41 secured to the support base 37. The adjustable support rod 29 is displaced to adjust the angular position of the drive mechanism 21 and therefore the force transmitting shaft 25 with respect to the support beam assembly 20 to drive conduit loops at different angles into the soil 27. Once the angle is selected the support rod is arrested by tightening the bolt 42 to clamp the adjustable support rod 39 to the pivotal linkage 41.

As shown in FIG. 4 the adjustable support rod 39 may also be provided with a plurality of spaced-apart through holes 43 and the means to arrest the support rod with the pivotal linkage 41 may be constituted simply by a bolt fastener positionable through a passage in the pivoting linkage 41 and a selected one of the spaced-apart through holes 43.

As shown in FIG. 3, the support base 37 may also be provided with a locking means in the form of a lock bolt 45 extending through the flange wall 46 of the support base 37 for engagement with the turret support base 35 to maintain the drive mechanism 21 at a desired angle with respect to the longitudinal axis 47 of the support beam assembly. A plurality of pin receiving holes 48 may be disposed about the turret support base 35 to receive the lock bolt 45 in a selected one of these to provide an immovable connection. Of course the lock bolt 45 may be secured to a hinge mechanism secured to the flange 46 to quickly engage and disengage the lock bolt 45 with a selected one of the holes 48 provided in the turret support base 35.

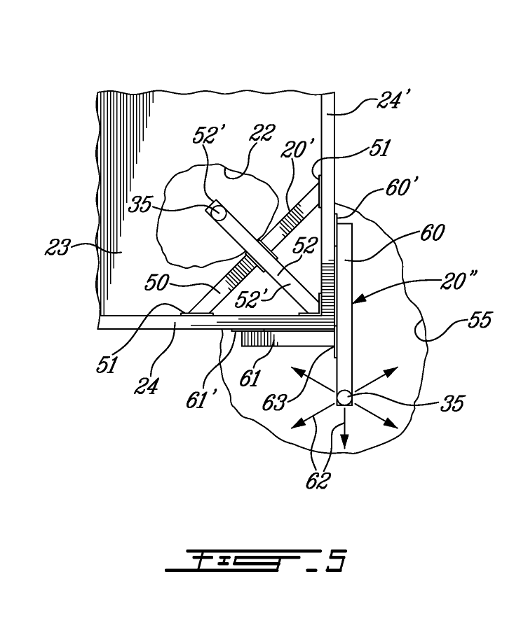

Referring now to FIG. 5, there is shown modifications of the support assembly of the present invention. FIG. 5 illustrates two modifications, one wherein the support assembly 20′ is secured to the opposed transverse foundation walls 24 and 24′ in the basement of an existing building structure but wherein the assembly comprises a diagonal support beam 50 having flanges 51 to secure to the transverse foundation walls and a transverse support beam 52 secured at one end 52′ to a corner of the opposed transverse foundation walls and projecting over the beam 50 and secured thereto and terminating over the hole 22 formed in the basement concrete floor 23. The free end 52′ of the transverse beam 52 is provided with the turret support base 35 for mounting the drive mechanism 21 thereto.

FIG. 5 also shows a further embodiment 20″ of the support beam assembly and herein constituted by two beam sections for securement to the opposed transverse foundation walls 24 and 24′ exteriorly of the building in a hole 55 excavated in the ground adjacent the foundation. This hole can be excavated by a small digging machine, such as a backhoe, which does not require much space to maneuver. As hereinshown, the support assembly 20″ is constituted by an elongated beam section 60 and a shorter transverse beam section 61 each provided with attachment flanges 60′ and 61′, respectively, for securement to the foundation wall. The flange planes of each of the attachment flanges 60′ and 61′ are oriented and angulated at an angle of 0 degrees (i.e. are parallel to) with respect to the straight axis of the beam sections 60 and 61 to which they are attached in order to support the beam sections 60 and 61 disposed in parallel to the opposed transverse walls 24 and 24′. The elongated beam section 60 projects exteriorly of the foundation walls and has the turret support base 35 secured at an extremity thereof whereby to support the drive mechanism 21 thereon. As hereinshown by the arrows 62 the force transmitting shafts can be oriented in a variety of angular positions to secure the conduit loops close to the foundation walls or under the foundation walls. The beam sections 60 and 61 are also interconnected together by an interconnecting flange 63.

In summary, the method of installing the geothermal conduit system under an existing basement concrete floor comprises the steps of firstly forming a hole in the basement concrete floor 23 spaced from opposed transverse foundation walls 24 and 24′ to expose the ground 27 thereunder. The support platform assembly is assembled and secured to opposed transverse foundation walls 24 and 24′, as above-described. The drive mechanism 21 is then secured on the turret support base 35. The force transmitting shafts are then assembled in the drive mechanism 21 which is driven by a pair of pistons 71, as shown in FIG. 3, to reciprocate the drive mechanism 70 to cause the force transmitting shaft 25 to be displaced in the direction of arrow 72 for driving same into the ground. Before doing so a geothermal flexible conduit loop 11 as shown in FIG. 1, is secured to the soil penetrating head 26. The soil penetrating head 26 may have various designs as described in my above-referenced co-pending application. After one loop has been pulled into the ground to a desired depth it is then necessary to reverse the drive mechanism 70 whereby the reciprocation of the pistons 71 will pull the force transmitting shaft 25 in a direction opposed to arrow 72. When the force transmitting shaft 25 is retracted, the soil penetrating head 26 is automatically disconnected from the end of the conduit loop. The drive mechanism is then re-oriented at a different angle with respect to the support beam assembly and may also be angulated at a different angle by means of the adjustable support rod 39. A further conduit loop is secured to the soil penetrating head and the drive mechanism 21 is operated to drive the force transmitting shaft 25 to locate another conduit loop at a different orientation into the soil. Many conduit loops are thus installed into the ground under the foundation at different orientations all through a single hole 22 formed in the basement concrete floor 23 of the building structure. After a predetermined number of these conduit loops have been installed into the ground, the top end portions of the conduit loops which are exposed over the hole 22 are then cut close to the ground and interconnected in series by the use of elbow couplings and tube sections with only an inlet and outlet end of the series connected loops exiting the hole 22. The hole 22 is then filled with concrete and the two exiting end sections are connected to a thermopump-type heat exchange device.

It is within the ambit of the present invention to cover any obvious modifications of the preferred embodiment described herein, provided such modifications fall within the scope of the appended claims.

1. An assembly for installing geothermal conduit loops into the ground under an existing foundation, the assembly comprising:
a support platform including a plurality of beam sections interconnected to form an elongated support beam having a longitudinal axis, the plurality of beam sections including first and second beam sections each defining a respective end of the elongated support beam, each of the first and second beam sections including an attachment flange attached to the respective end of the elongated support beam, each attachment flange defining a flange plane oriented non-perpendicularly to the longitudinal axis, each attachment flange configured for detachable securement to a respective one of adjoining walls of the foundation;
a turret support base secured to the support platform;
a drive support base pivotally and detachably engaged on the turret support base such as to be pivotable relative thereto about a first axis;
a drive mechanism engaged to the drive support base such as to be pivotable relative thereto about a second axis non-parallel to the first axis; and
a force transmitting shaft drivingly engaged to the drive mechanism and extending downwardly therefrom, the force transmitting shaft having a soil penetrating head configured to penetrate the soil while engaging one of the conduit loops when the force transmitting shaft is driven by the drive mechanism.

2. The assembly as defined in claim 1, wherein the turret support base is secured to a top wall of one of the plurality of beam sections.

3. The assembly as defined in claim 1, wherein adjacent ones of the plurality of beam sections include interconnecting flanges connected to one another.

4. The assembly as defined in claim 1, wherein the plurality of beam sections include the first beam section, the second beam section, and a third beam section extending between and connected to the first and second beam sections, the turret support base secured to a top wall of the third beam section.

5. The assembly as defined in claim 1, wherein the support base includes a transverse beam section extending transversely to the elongated support beam, the transverse beam section having opposed first and second ends and being connected to the elongated support beam between the first and second ends, the first end including a corner attachment flange configured to engage a corner defined by the adjoining walls, the turret support base secured to a top wall of the transverse beam section at the second end thereof.

6. The assembly as defined in claim 1, wherein each attachment flange includes through bores for receiving anchor bolts.

7. The assembly as defined in claim 1, wherein the drive mechanism is connected to the drive support base by an adjustable support rod pivotally connected at a top end to the drive mechanism, the support rod guidingly received and displaceable in a pivoting linkage secured to the turret support base, the support rod engaged to the pivoting linkage in a selected one of a plurality of positions.

8. The assembly as defined in claim 7, wherein the support rod engaged to the pivoting linkage in a selected one of a plurality of positions by a clamp.

9. The assembly as defined in claim 7, wherein the support rod has a plurality of spaced-apart through holes, the support rod engaged to the pivoting linkage by a fastener positionable through a passage in the pivoting linkage and a selected one of the spaced-apart through holes of the support rod.

10. The assembly as defined in claim 1, wherein each of the plurality of beam sections is a hollow metal beam including a carrying handle secured thereto.

11. The assembly as defined in claim 1, wherein the drive support base includes a lock bolt extending therethrough and engaged with a selected one of a plurality of pin receiving holes defined in a circular array on a top face of the turret support base.

12. The assembly as defined in claim 1, wherein each flange plane is oriented at an angle of about 45° with respect to the longitudinal axis.

13. An assembly for installing geothermal conduit loops into the ground adjacent an existing foundation, the assembly comprising:
a support platform including:
a first beam section having a first longitudinal axis and opposed first and second ends,
a first attachment flange connected to the first beam section adjacent the second end thereof, the first attachment flange defining a first flange plane parallel to the first longitudinal axis,
a second beam section having a second longitudinal axis non-parallel to the first longitudinal axis and opposed first and second ends, the first end of the second beam section being connected to the first beam section between the first and second ends thereof,
a second attachment flange connected to the second beam section adjacent the second end thereof, the second attachment flange defining a second flange plane parallel to the second longitudinal axis,
wherein the first and second attachment flanges are each configured for detachable securement to an exterior surface of a respective one of adjoining walls of the foundation;
a turret support base secured to the first beam section adjacent the first end thereof;
a drive support base pivotally and detachably engaged on the turret support base such as to be pivotable relative thereto about a first axis;
a drive mechanism engaged to the drive support base such as to be pivotable relative thereto about a second axis non-parallel to the first axis; and
a force transmitting shaft drivingly engaged to the drive mechanism and extending downwardly therefrom, the force transmitting shaft having a soil penetrating head configured to penetrate the soil while engaging one of the conduit loops when the force transmitting shaft is driven by the drive mechanism.

14. The assembly as defined in claim 13, the first and second beam section extend perpendicularly to one another.

15. The assembly as defined in claim 13, wherein each of the first and second attachment flanges include through bores for receiving anchor bolts.

16. The assembly as defined in claim 13, wherein the drive mechanism is connected to the drive support base by an adjustable support rod pivotally connected at a top end to the drive mechanism, the support rod guidingly received and displaceable in a pivoting linkage secured to the turret support base, the support rod engaged to the pivoting linkage in a selected one of a plurality of positions.

17. The assembly as defined in claim 16, wherein the support rod engaged to the pivoting linkage in a selected one of a plurality of positions by a clamp.

18. The assembly as defined in claim 16, wherein the support rod has a plurality of spaced-apart through holes, the support rod engaged to the pivoting linkage by a fastener positionable through a passage in the pivoting linkage and a selected one of the spaced-apart through holes of the support rod.

19. The assembly as defined in claim 13, wherein each of the plurality of beam sections is a hollow metal beam including a carrying handle secured thereto.

20. The assembly as defined in claim 13, wherein the drive support base includes a lock bolt extending therethrough and engaged with a selected one of a plurality of pin receiving holes defined in a circular array on a top face of the turret support base.
